(19) United States
(12) Patent Application Publication
(10) Pub. No.: US 2024/0102668 A1
(43) Pub. Date: Mar. 28, 2024

(54) LINKING ABOVE GROUND AND UNDERGROUND GREEN ENERGY TECHNOLOGIES

(71) Applicant: Shaul Shalev, GY Savyon (IL)

(72) Inventor: Shaul Shalev, GY Savyon (IL)

(21) Appl. No.: 17/768,905

(22) PCT Filed: Nov. 3, 2020
(86) PCT No.: PCT/IL2020/051138

§ 371 Date: Apr. 14, 2022

Related U.S. Application Data
(60) Provisional application No. 62/931,230, filed on Nov. 6, 2019.
(60) Provisional application No. 62/955,485, filed on Dec. 31, 2019.

(51) Int. Cl. F24D 17/00; F24T 10/30

(52) U.S. Cl. CPC F24D 17/0021; F24T 10/30; F24D 2200/11; F24D 2200/12; F24T 2010/56

(57) ABSTRACT

Embodiments in the current disclosure relate to improving the efficiencies of geothermal heating and cooling systems, solar based energy production and other “green-energy” generators by linking them together for increasing the usable energy which is extractable from each generator and/or energy storage reservoir. In some embodiments, increased efficiencies of both geothermal solutions and systems exploiting solar energy or other energy generators are achieved by linking them together. Preferably but not necessarily the linking includes smart-contacts which automatically enhance the links according to temporal measurable values characterizing the connectable modules and devices. A geothermal reservoir may include an inlet with a large surface area between a shell of the reservoir and the ground.

### RELATED APPLICATION/S

This application claims the benefit of priority under 35 USC § 119(e) of U.S. Provisional Patent Application No. 62/931,230 filed 6 Nov. 2019, the contents of which are incorporated herein by reference in their entirety.

This application claims the benefit of priority under 35 USC § 119(e) of U.S. Provisional Patent Application No. 62/955,485 filed 31 Dec. 2019, the contents of which are incorporated herein by reference in their entirety.

### FIELD AND BACKGROUND OF THE INVENTION

The present invention, in some embodiments thereof, relates to geothermal energy storage and, more particularly, but not exclusively, to a system and method to improve green energy system performance.

U.S. Pat. No. 9,709,337 appears to disclose that, “An arrangement for storing thermal energy, having at least one subterranean chamber for holding a first fluid is provided. A passage holding a second fluid is extended outside at least a part of the chamber. At least one channel is arranged to allow fluid communication of the first fluid between different sections of the chamber, and/or allow fluid communication of the second fluid between different sections of the passage.”

U.S. Pat. No. 7,082,779 appears to disclose, “A geothermal accumulator and an air-conditioning system using the geothermal accumulator, said geothermal accumulator includes a well pipe and a heat-accumulating pipe inserted within the well pipe coaxially, the lower portion and the upper portion of the well pipe are provided with inlet holes and outlet holes for underground water respectively, said heat-accumulating pipe is provided with a water-collecting chamber, a diffluent chamber, a heat-exchanging chamber and a water-accumulating chamber from the bottom up in sequence, the heat-exchanging chamber is provided with a plurality of axially disposed heat-exchanging pipes communicating with the diffluent chamber and water-accumulating chamber respectively, and a plurality of baffles attached to the outside of the heat-exchanging pipes, gap exists between the baffles and the heat-exchanging pipes, the upper portion of the heat-exchanging chamber is connected with a returning pipe, and the lower portion is connected with a discharging pipe, water inlet holes and drain holes are provided respectively in the side wall of the water-collecting chamber and the water-accumulating chamber. Said geothermal accumulator can be used in air conditioner system.”

U.S. patent Ser. No. 10/387,581 appears to disclose that, “A method of designing an optimized heating and cooling system includes: (1) automatically importing data from an energy model into an optimization model; (2) simulating energy use of a virtual heating and cooling system operating a thermal source or sink with the optimization model based upon the data from the energy model to obtain an optimized system design; (3) developing controls for an actual heating and cooling system based upon the optimized system design; and (4) automatically exporting the controls directly to a controller for the actual heating and cooling system.”

Korean patent no. KR102044681 appears to disclose, “a heat storage type heat pump system including an underground heat exchanger and a control method thereof. One aspect of a heat storage type heat pump system including an underground heat exchanger, according to an embodiment of the present invention, comprises: a heat storage tank in which a heat exchange fluid is stored; at least one underground heat exchanger performing heat exchange between the heat exchange fluid received from the heat storage tank and the ground; a heat pump receiving the heat exchange fluid from the heat storage tank; an air conditioning load performing heat exchange with the heat exchange fluid supplied to the heat pump; and a hot water load storing hot water heated by heat exchange with heat exchange fluid stored in the heat storage tank. The heat storage tank includes first and second heat storage tanks. According to the temperature of the heat exchange fluid stored in the first heat storage tank, the heat exchange fluid stored in the first heat storage tank is supplied to the heat pump, or the heat exchange fluid stored in the first heat storage tank is transferred to the second heat storage tank to be mixed with the stored heat exchange fluid and supplied to the heat pump, or the heat exchange fluid stored in the first heat storage tank is circulated through the underground heat exchanger and transferred to the second heat storage tank to be supplied to the heat pump.”

U.S. Pat. No. 4,008,709 appears to disclose, “A thermal energy storage system including a thermal energy storage tank and a pair of thermal energy exchange tanks disposed in a different horizontal plane than the thermal energy storage tank. Each of the tanks contain a heat exchange medium and are in fluid communication with each other for circulation of the heat exchange medium between the exchange tanks and the storage tanks by convection. The exchange tanks contain a heat exchange coil which is in fluid communication with a first heat exchanger for heating or cooling the medium in the exchange tank. The storage tank is in fluid communication with a second heat exchanger for the transfer of the heat exchange medium therebetween to heat or cool a structure. The system is disposed beneath the ground adjacent the structure being heated or cooled and an envelope of non-coherent material is disposed about the system to provide a corrosion resistant barrier between the tanks, and the adjacent earth and to act as a conduit for the transfer of thermal energy between the system and the surrounding earth.”

Chinese patent no, CN102483311 appears to disclose, “a thermal energy storage system comprising at least one thermal reservoir and at least one thermal energy transfer means that, at least at times, are able to transfer thermal energy from at least one first section of the thermal reservoir to at least one second section of the thermal reservoir. The invention also relates to a method changing the energy distribution of a thermal reservoir wherein thermal energy is transferred from at least one first section of the thermal reservoir to at least one second section of the thermal reservoir.”

Other art includes: Jeffrey D. Spitler and Laura E. Southard, Xiaobing Liu; Performance of the HVAC Systems at the ASHRAE Headquarters Building; GEO—The Geothermal Exchange Organization 312 South 4th Street Springfield, IL 62701

### SUMMARY OF THE INVENTION

According to an aspect of some embodiments of the invention, there is provided a system for geothermal heat storage including: A tank for storing a fluid underground; An inlet pipe to the tank configured to facilitate heat transfer between fluid passing through the inlet and a ground.

According to some embodiments of the invention, the inlet includes a high surface area inlet pipe positioned along an outer shell of the tank.

According to some embodiments of the invention, the inlet includes a high surface area pipe underground at the near vicinity of the tank.

According to some embodiments of the invention, the system further includes: insulation between the high surface area pipe and the tank.

According to some embodiments of the invention, the system further includes: insulation between the tank and the ground.

According to some embodiments of the invention, the high surface area pipe winds along the outer shell of the tank.

According to some embodiments of the invention, the high surface area pipe winds around the outer shell of the tank.

According to some embodiments of the invention, the high surface area pipe winds spirally around the outer shell of the at least one tank.

According to some embodiments of the invention, the system further includes a high heat conductivity filling between the high surface area pipe and a ground.

According to some embodiments of the invention, an area of contact of the pipe with a ground is between 1/10 to 10 times an area of contact of the tank with the ground.

According to some embodiments of the invention, a ratio of volume of fluid to surface area in contact with a ground of the tanks is at least 10 times as large as ratio of volume of fluid to surface area in contact with the ground of the high surface area pipe.

According to an aspect of some embodiments of the invention, there is provided a method of building a geothermal reservoir system including: dig a trench; position at least one fluid storage tank inside the trench; connect a heat exchanger to the at least one tank, the heat exchanger supplying heat communication between a fluid inlet of the fluid storage tank and a ground.

According to some embodiments of the invention, the heat exchanger includes a pipe, the method further including connecting an outlet of the pipe to an inlet of the fluid storage tank.

According to some embodiments of the invention, the method further includes connecting an inlet of the pipe to an outlet of a heat sink of a heat pump.

According to an aspect of some embodiments of the invention, there is provided a heat management system including: an underground heat storage reservoir; a source of fluid having temperatures which differs from a ground temperature around the reservoir; a fluid and heat transport network interconnecting the heat storage reservoir and the source of fluid; a controller controlling the transport network.

According to some embodiments of the invention, the system further includes: an aboveground fluid and heat reservoir.

According to some embodiments of the invention, the system further includes: at least one of an end-user and an application using the water accumulated in the reservoir.

According to some embodiments of the invention, the system further includes: at least one of an end-user and an application using heat accumulated in the reservoir.

According to some embodiments of the invention, the system further includes: a controller configured to selectively direct heat flows along the heat transport network.

According to some embodiments of the invention, the source of fluid includes at least one of a green energy generator, a heat exchanger, a heat pump, a cold external fluid source, a hot external fluid source, a solar water heater and a photovoltaic panel.

According to some embodiments of the invention, the source of fluid includes multiple sources at different temperatures.

According to some embodiments of the invention, the controller controls heat flows between the multiple sources of fluid and between each multiple sources of fluid and the reservoir.

According to some embodiments of the invention, the controller is configured to manage flow of the heat in the system to maintain the reservoir at a preset target temperature.

According to some embodiments of the invention, the target temperature is as close as possible to a preset target value for a specific application which uses water from the reservoir.

According to some embodiments of the invention, the specific application includes irrigation of a crop.

According to some embodiments of the invention, the heat storage reservoirs includes a fluid tank.

According to some embodiments of the invention, the fluid tank includes a cover dividing the tank into a first space and a second space.

According to some embodiments of the invention, the first space is used for storing a fluid at a first temperature and the second space is used for storing another fluid at a different temperature.

According to some embodiments of the invention, the first space is used for storing a fluid at a first temperature and the second space is used for storing an item that benefits from storage in a controlled environment.

According to some embodiments of the invention, the heat transport network includes a network of interconnecting pipes and valves and/or wherein the controller controls opening and closing of the valves to direct fluid flow in the network, utilizing logic embedded in the controller.

According to some embodiments of the invention, the system includes a high surface area tube directed along a shell of the tank.

According to some embodiments of the invention, the high surface area tube is connected to an inlet of the tank.

According to some embodiments of the invention, the fluid source includes at least one of a fluid heater and a fluid cooler and wherein the controller is configured to selectively direct fluid between the fluid source the reservoir and the heat pump.

According to some embodiments of the invention, the fluid source includes a photovoltaic panel having a heat exchanger and wherein the controller is configured to selectively direct heated or cooled fluid between the heat exchanger of the photovoltaic panel and the reservoir and to direct heated fluid between the heat exchanger of the photovoltaic panel and a heat pump.

According to some embodiments of the invention, the system further includes: a fluid source at a temperature preferred over a geothermal equilibrium and wherein fluid from the fluid source is used to move fluid in the reservoir away from geothermal equilibrium.

According to some embodiments of the invention, fluid from the fluid source is mixed with fluid in the reservoir.

According to some embodiments of the invention, the system further includes at least one of a separate tank and a separate closed pipe system for fluid from the fluid source and wherein fluid from the fluid source is kept separate from fluid in the reservoir while heat is exchanged between fluid in the fluid source and fluid in the reservoir.

According to some embodiments of the invention, the fluid source includes a source of warm fluid.

According to some embodiments of the invention, the fluid source includes a source of cold water.

According to some embodiments of the invention, the fluid transported from the reservoir is used to improve the efficiency of a green-energy generator by shifting its operation temperature to a value that is more favorable to the green energy production processes.

According to an aspect of some embodiments of the invention, there is provided a method of geothermal heat management: directing fluid at temperature which is different than a geothermal equilibrium to a geothermal reservoir; channeling the fluid through a high surface area tube external of the reservoir, thereby bringing a temperature of the fluid towards equilibrium with a ground; inserting the fluid into the reservoir after the channeling.

According to some embodiments of the invention, the channeling through the high surface area tube is preformed when the fluid has a temperature that is not preferred over the geothermal equilibrium, the method further including: sending the fluid directly to the reservoir not through the high surface area tube when a temperature of the fluid is preferred over the geothermal equilibrium.

According to an aspect of some embodiments of the invention, there is provided a method of geothermal heat management including: importing fluid at temperature preferred over to a geothermal equilibrium; transferring heat from the fluid to a geothermal reservoir.

According to some embodiments of the invention, the reservoir includes a fluid tank, the method further including inserting the fluid into the tank.

According to some embodiments of the invention, the reservoir includes a fluid tank the method further including: separating the imported fluid from a fluid in the tank and transferring heat between the source fluid and the fluid in the tank.

According to some embodiments of the invention, the heat management system is configured for controlling the temperature of the stored fluid including at least one of maximizing the temperature of stored fluid depending on availability of imported fluid, minimizing the temperature of stored fluid, depending on availability of imported fluid, and stabilizing the temperature of the stored fluid in a value different from the geothermal equilibrium.

Unless otherwise defined, all technical and/or scientific terms used herein have the same meaning as commonly understood by one of ordinary skill in the art to which the invention pertains. Although methods and materials similar or equivalent to those described herein can be used in the practice or testing of embodiments of the invention, exemplary methods and/or materials are described below. In case of conflict, the patent specification, including definitions, will control. In addition, the materials, methods, and examples are illustrative only and are not intended to be necessarily limiting.

As will be appreciated by one skilled in the art, some embodiments of the present invention may be embodied as a system, method or computer program product. Accordingly, some embodiments of the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, some embodiments of the present invention may take the form of a computer program product embodied in one or more computer readable medium(s) having computer readable program code embodied thereon. Implementation of the method and/or system of some embodiments of the invention can involve performing and/or completing selected tasks manually, automatically, or a combination thereof. Moreover, according to actual instrumentation and equipment of some embodiments of the method and/or system of the invention, several selected tasks could be implemented by hardware, by software or by firmware and/or by a combination thereof, e.g., using an operating system.

For example, hardware for performing selected tasks according to some embodiments of the invention could be implemented as a chip or a circuit. As software, selected tasks according to some embodiments of the invention could be implemented as a plurality of software instructions being executed by a computer using any suitable operating system. In an exemplary embodiment of the invention, one or more tasks according to some exemplary embodiments of method and/or system as described herein are performed by a data processor, such as a computing platform for executing a plurality of instructions. Optionally, the data processor includes a volatile memory for storing instructions and/or data and/or a non-volatile storage, for example, a magnetic hard-disk and/or removable media, for storing instructions and/or data. Optionally, a network connection is provided as well. A display and/or a user input device such as a keyboard or mouse are optionally provided as well.

Any combination of one or more computer readable medium(s) may be utilized for some embodiments of the invention. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device.

Program code embodied on a computer readable medium and/or data used thereby may be transmitted using any appropriate medium, including but not limited to wireless, wireline, optical fiber cable, RF, etc., or any suitable combination of the foregoing.

Computer program code for carrying out operations for some embodiments of the present invention may be written in any combination of one or more programming languages, including an object-oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) and/or a mesh network (meshnet, emesh) and/or a wide area network (WAN), or the connection may be made to an external computer (for example, through the Internet using an Internet Service Provider).

Some embodiments of the present invention may be described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

Some of the methods described herein are generally designed only for use by a computer, and may not be feasible or practical for performing purely manually, by a human expert. A human expert who wanted to manually perform similar tasks might be expected to use completely different methods, e.g., making use of expert knowledge and/or the pattern recognition capabilities of the human brain, which would be vastly more efficient than manually going through the steps of the methods described herein.

Data and/or program code may be accessed and/or shared over a network, for example the Internet. For example, data may be shared and/or accessed using a social network. A processor may include remote processing capabilities for example available over a network (e.g. the Internet). For example, resources may be accessed via cloud computing. The term “cloud computing” refers to the use of computational resources that are available remotely over a public network, such as the internet, and that may be provided for example at a low cost and/or on an hourly basis. Any virtual or physical computer that is in electronic communication with such a public network could potentially be available as a computational resource. To provide computational resources via the cloud network on a secure basis, computers that access the cloud network may employ standard security encryption protocols such as SSL and PGP, which are well known in the industry.

### BRIEF DESCRIPTION OF THE SEVERAL VIEWS OF THE DRAWING(S)

Some embodiments of the invention are herein described, by way of example only, with reference to the accompanying drawings. With specific reference now to the drawings in detail, it is stressed that the particulars shown are by way of example and for purposes of illustrative discussion of embodiments of the invention. In this regard, the description taken with the drawings makes apparent to those skilled in the art how embodiments of the invention may be practiced.

In the drawings:

FIG. 1 illustrates a method of designing a system for heat management in accordance with an embodiment of the current invention;

FIG. 2 is a block diagram of a heat management system in accordance with an embodiment of the current invention

FIG. 3 is a schematic illustration of a heat management system in accordance with an embodiment of the current invention;

FIG. 4 is a schematic illustration of a geothermal reservoir in accordance with an embodiment of the current invention;

FIG. 5 is a schematic view of a geothermal reservoir including extra inlet pipes in accordance with an embodiment of the present invention

FIG. 6 is a schematic illustration of a geothermal reservoir for use with multiple streams of separate fluids in accordance with embodiments of the current invention;

FIG. 7 is a schematic illustration of a dual tank geothermal reservoir for use with multiple streams of separate fluids in accordance with embodiments of the current invention;

FIG. 8 is a flow chart illustration of installing a geothermal reservoir in accordance with an embodiment of the current invention;

FIG. 9 is a block diagram of a heat management system in accordance with an embodiment of the current invention;

FIG. 10 is a flow chart illustration of changing a temperature of a geothermal reservoir with an external fluid source in accordance with an embodiment of the current invention; and

FIG. 11 is a block diagram illustration of a geothermal heating system in accordance with an embodiment of the current invention.

### DESCRIPTION OF SPECIFIC EMBODIMENTS OF THE INVENTION

The present invention, in some embodiments thereof, relates to geothermal energy storage and, more particularly, but not exclusively, to a system and method to improve green energy system performance.

### Overview

An aspect of some embodiments of the current invention relates to improving the efficiencies of geothermal heating and cooling systems, solar based energy production and other “green-energy” generators by linking them together. Optionally the linking increases the usable energy which is extractable from each generator. Alternatively or additionally, the system supplies a liquid at a preset desired temperature. In some embodiments, increased efficiencies of both geothermal solutions and systems exploiting solar energy or other energy generators are achieved by linking them together. Preferably but not necessarily the linking includes smart-contacts which automatically enhance the links according to temporal measurable values characterizing the connectable modules and devices.

In some embodiments, a system and/or method is disclosed to increase efficiency of “green” energy production at the deployment site either through improved management of geothermal air-conditioning modules and/or by increasing efficiency of other green-energy generators such as solar radiation-based modules targeted at electrical power and/or solar heated water production. For example, increased efficiency may be achieved through linking the different modules on site by a network of heat transfer and/or storage system. For example, heat may be transferred in the form of hot and/or cool fluid. Optionally the fluid is transferred using pipes interconnected with valves. Optionally the fluid and/or heat is stored in tanks. For example, tanks may be linked by pipes and/or valves. Optionally, the valves are automatically controlled. For example, cold water may be as cold as and/or colder than geothermal deep ground temperature and/or hot fluids may be as hot as and/or hotter than the geothermal ground temperature. For example, fluid temperatures in the system may range between 10 to 50 degrees Centigrade and/or between 2 to 70 degrees and/or between 2 to 90 degrees and/or between −10 to 140 degrees.

In some embodiments, the method includes enabling fluids stored and/or streamed through a network of tanks and pipes included in the system to circulate. Heat may be transferred according to the flow and/or temperature gradients in the fluid. Flow may be natural and/or powered by pumps and/or powered by hydraulic head differentials in the system. Optionally, flow routing is automatically changeable and governed by remote and/or locally controlled valves, for example the temperature of the usable liquid may be adjusted to a desired temperature. For example, the desired temperature may be according to the specifications of a device (e.g. a heat pump and/or heat exchanger) and/or to increase efficiency. For example, the desired temperature may be maximal, or minimal depending on available liquid sources and/or preset to specific values as required by an end-user or application. For example, the valves are optionally placed on a pipe network connecting system modules and/or the fluid sources. For example, a geothermal reservoir may include a tank have a capacity ranging between 10 liters to 500 liters and/or between 500 liters to 1 m³ and/or between 1 m³ to 3 m³ and/or between 3 m³ to 6 m³ and/or between 6 to 30 m³ and/or between 30 to 100 m³.

An aspect of some embodiments of the current invention relates to a geothermal reservoir having in inlet in heat communication with a heat exchanger and/or the ground. For example, the inlet may hold a volume fluid ranging between 1/1000 to 1/200 of the tank and/or between 1/200 to 1/50 and/or between 1/50 to 1/10 and/or between 1/10 to ½ the volume of the tank. Optionally, the tank and the heat exchanger may have a surface in heat contact with the ground, for example the ratio of the surface area of contact of the tank to the ground to the surface area of contact of the heat exchanger to the ground may range between 1/1000 to 1/200 and/or between 1/200 to 1/50 and/or between 1/50 to 1/10 and/or between 1/10 to ½ and/or between 1000 to 200 of the tank and/or between 200 to 50 and/or between 50 to 10 and/or between 10 to ½ and/or between ½ to 2. For example, the ratio of volume of the tank to volume of the inlet may range between 10 to 30 and/or between 1 to 10 and/or between 30 to 300.

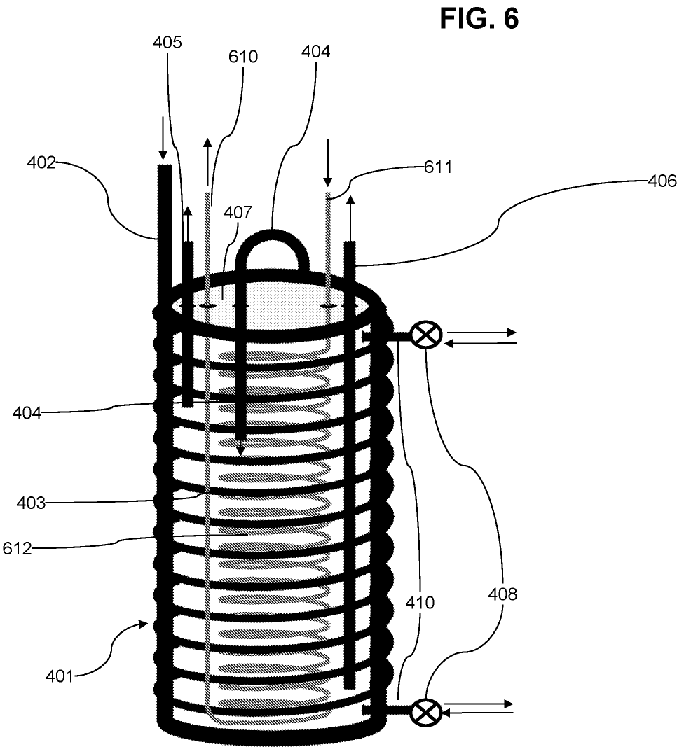

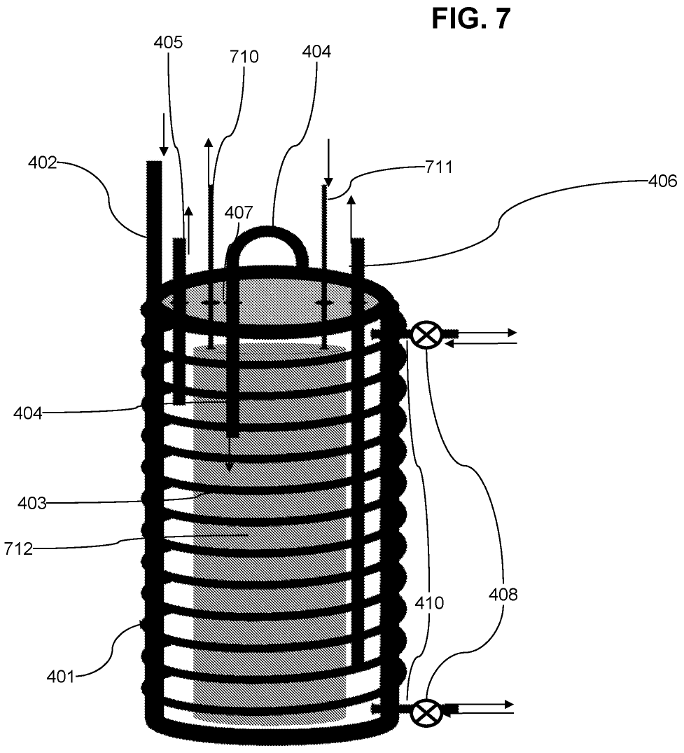

In some embodiments, there may be geothermal reservoir with a heat exchanger to a fluid supplied by a source having a temperature that is more desirable than the ground temperature. For example, the heat exchanger may include a pipe passing through the reservoir and/or a tank inside but separate from the reservoir (e.g. as illustrated below in FIGS. 6 and 7). For example, the heat exchanger may hold a volume fluid ranging between 1/1000 to 1/200 of the tank and/or between 1/200 to 1/50 and/or between 1/50 to 1/10 and/or between 1/10 to ½ the volume of the tank. Optionally, the tank and the heat exchanger may have a surface in heat contact with each other and/or the tank may have a surface of in heat contact with the ground. For example the ratio of the surface area of contact of the tank to the ground to the surface area of the heat exchanger to the tank may range between 1/200 to 1/50 and/or between 1/50 to 1/10 and/or between 1/10 to ¼ and/or between 200 to 50 and/or between 50 to 10 and/or between 10 to ¼ and/or between ¼ to 4.

In some embodiments, the valve logic (open/closed) of a valve in a heat management system is dictated by temperature dependent automatic and/or AI based algorithms. For example, the algorithms may be developed at the system set-up at the deployment site, affected by the site characteristics, the technical parameters of the buildings, the participating system modules and/or the actual use of the infrastructure utilizing the system. The AI logic is optionally based on continuous sensing of temporal temperature values of the stored or flowing fluid sources available for employment by the system. Having such temporal temperature values and knowing, from system set-up, the alternative flow routes between the modules, may be used to select, for example, flow routes in the system. Once selected the selected routing of the fluid is optionally activated by transferring open/lock commands to relevant valves. In some embodiments, temperature sensing is continuous and/or the fluid routing is continuously calculated and/or adjusted. For example, when an alternative route is found to better contribute to the system efficiency, or targeted fluid temperature, relevant commands are sent to the relevant valves and/or the new route is activated while the former route is either blocked and/or remains active depending on the calculated status of the system.

In some embodiments, the system is modular. For example, changes and/or addition of an employable water source and/or green energy generator can be connected to the system through the fluid network, Relevant valves may be added and/or a relevant update of the flow routing and the related AI algorithms may be performed. Optionally, the system continues to detect energy use and/or circumstances and/or continues to train the AI routine, for example, to identify new modes, recommend new modes, recommend desirable changes to the system, identify breakdown of the system, identify new demands on the system and/or improve efficiency. In some embodiments, the system and/or method may be updatable using AI technology based on centralized and/or distributed algorithms.

In many locations, the temperature of the soil and rocks few meters below ground level remains stable near its year-round near the average (365 days/24 hour) of the ground surface temperature. Depending on different parts of the globe, the average values are location dependent but generally range between 20-10 deg. C. Typically the year-round averages are higher than the above-ground temperature in the winter and below the above ground temperature in the summer. In some embodiments, fluid is circulated to brings its temperature near that of “mother-earth”, for example, through an underground geothermal system. Optionally, the fluid is then streamed into a heat pump serving as the basis for heating (e.g. in the winter) or cooling (e.g. in the summer). In some embodiments, water that was contacted thermally with the ground and/or is below the ambient temperature is used for cooling in the summer and/or water that was contacted thermally with the ground and/or is above the ambient temperature is used for heating in the winter. This can increase the efficiency of heat pumps, for example in an above ground building, in comparison to the ones based on heat exchange with the above-ground-air. In some cases, the warmer/colder the fluid temperature during winter/summer, respectively, contribute to higher the energy efficiency of the entire system. Commonly, the fluid outflowing back from the heat-exchange device into the geothermal circuitry will naturally be warmer/colder than the influx during cooling/warming operation of the system, respectively.

In some embodiments, solar-energy-based systems for generating electricity and/or water utilize electric-current sources such as PV cells and/or solar-based heated water panels for multitude of applications. In some embodiments, efficiencies of the solar-based solutions are higher during day time. Optionally, storing energy produced before sun-down for use at night may increase the efficiency and/or overall usability solar generated energy. For example, energy may be stored as hot fluid in a tank, for example, an underground tank and/or a geothermal tank and/or overground tank and/or an insulated tank and/or a tank within a tank, for example, as described in any of the embodiments herein. Alternatively or additionally, the energy may be transferred as heat to a fluid and/or another material and stored. For example, energy may be stored as a flowable hot or cold fluid. Optionally, the fluid may be streamed to a certain target module such as a heat exchange module and/or a heat pump. In some embodiments, streaming a fluid at a desired temperature may increase the efficiency of energy transfer processes at the heated or cooled targeted module.

In some embodiments, the efficiency of certain solar-energy generators, is temperature dependent. For example, efficiency of PV cells may significantly decrease with the increase of device temperature. In some cases, as exposure to solar radiation increases and/or as the ambient temperature increases, the temperature of the generators increases and/or efficiency is reduced. In some embodiments, it is cost-effective solutions to lower the temperature of the current generating device to produce positive impact on the average efficiency of the electric power generating system.

In some embodiments, solar water-heaters will increase their efficiency when the temperature of water entering the heaters increases. Optionally, a water source having temperature that is higher in comparison to the temperature of the public water system is connected to the heaters. For example, this may produce hotter water and/or shorter heating time and/or increased volume heated water for a desired water temperature value.

In some cases, the following general principles may be applied to achieve a more efficient solution to energy production, storage and/or use.

Heat pump operating for the purpose of heating or cooling will in many cases use reduced investment of energy when the influx into the heat-pump is closer to the desired output temperature. For example, a water-based heat-pump may be more energy efficient when the incoming water is hotter for heating purposes and/or when incoming water is colder for cooling purposes.

Underground water reservoirs will in many cases tend toward a consistent static equilibrium temperature near the underground temperature when passively locked. When an underground reservoir is heated or cooled by a heat flow, for example, by an inflow of water, the underground water reservoir may absorb and/or give off heat to the ground in a way that tends to an equilibrium with the surrounding ground “heat-sink”. For example, when the incoming heat flow is constant the system may tend towards a dynamic equilibrium temperature. The temperature difference between the dynamic equilibrium and the ground temperature is generally increased when the amount of heat flow is greater. For example, a greater heat flow may be due to a greater quantity of incoming water and/or a great temperature gap between the incoming water and static equilibrium temperature. For example, when the incoming heat flow is reduced or stops, the system may tend to return to the static equilibrium underground temperature. In the common case, where the heat flow is not reversed, the time to return to static equilibrium with the ground may increase for greater heat flows. In many cases, increasing the surface-area to volume ratio of the reservoir increases the rate at which the reservoir approaches its equilibrium temperature and/or reduces the temperature difference between the reservoir and the ground at dynamic equilibrium.

In some embodiments, fluid may be fed into a tank and the tank allowed to come to equilibrium with the ground. Optionally, for example, when the ground temperature is more preferable than the incoming water temperature, a heat exchanger may be supplied to bring the water towards an equilibrium temperature with the ground at an inlet to the tank. For example, an inlet pipe may have a high surface area in contact with the ground. Alternatively or additionally, an inlet or a tank may be insulated (for example, for use when the incoming water temperature is more preferable than the ground temperature). In some embodiments, a tank may include multiple inlets and/or there may be multiple tanks with different levels of insulation and/or incoming fluid may be directed to a selected tank and/or inlet according to the preferred temperature and/or the fluid temperature and/or the ground temperature and/or the speed at which equilibrium is to be approached

In some embodiments, a few meters of distance between underground reservoirs will justify considering the reservoirs independent with regards to their equilibrium relations with the surrounding ground heat-sink.

In some cases, waste water temperature, particularly at the exit of home/office from which they emerge, are warmer in the winter than the clean water supply to the building.

In some cases, the temperature of clean water supply to a building is determined by the water temperature at the source and the piping system from the source to the building. The temperature may be either higher or lower than the equilibrium temperature of an underground reservoir near the building. Consequently, streaming water from the public/local supply into the reservoir can heat/cool it with respect to the surrounding ground-heat-sink, or with respect to the actual temperature at the reservoir when it is not in equilibrium with the ground, depending on the temperature difference between the supply and the reservoir.

Solar water heaters, for example, those utilized for supplying hot water to water tanks in a building, may sometimes generate hot water in temperatures and/or quantities that are desired and/or useful. For example, water at too high a temperature may be blocked from flowing into a full tank, for example for protecting its functionality and the safety of the hot-water users. In some embodiments, excess heat and/or excess hot water and/or water at a temperature above a desired temperature may be directed to a heat pump and/or into a heat storage reservoir (for example an underground reservoir) The quantities of heat and/or water directed to each destination may depend on the amount of the available excess quantity and/or the current demand for heat and/or expected supplies and/or expected demands. For excess, the excess heat and/or hot water may serve for elevating the efficiency of the heat-pump when operated for heating purposes. Heat and/or hot water directed to a reservoir may be usable during longer periods, before reaching equilibrium with the surrounding ground, including in periods when the on-going solar heating is not active. Optionally, a reservoir may be insulated and/or the rate of heat exchange to the environment may be adjustable (e.g. by using one pipe [e.g. inlet and/or outlet of the reservoir] for higher heat exchange with the environment and another pipe for improved insulation from the environment).

In some embodiments, solar power collection can be made more efficient by cooling components of the system. For example, in some embodiments, electric current generation utilizing solar radiation may be characterized by a decrease of the electric power values when the temperature of the active generators increases. For example, when the system is based on PV (photo-voltaic) panels. In some cases, higher ambient temperature results in a decline of the power values per giver solar radiation flux. For example, the raised ambient temperatures may reduce efficiency of air-cooling of the panels. In some embodiments, forced water cooling of the panels will be used. For example, forced water cooling may increase efficiency of cooling and/or current production. Usable water sources characterized by water temperature which is significantly lower than the panel temperatures and/or water-cooled heat sinks can drive the panel temperature downward, resulting with higher electric power production efficiency and/or generation of hotter water source (flowing out of the heat-sink) which is optionally usable for the operation of air-conditioning heat-pumps in heating mode and/or geothermal storage for later use.

Materials that are usable for spectrum shift of absorbed solar radiation, may be used in a cooling effect of a layer (referred to here as E/O cooling). In some embodiments, a pipe and/or a grid of pipes are optionally filled with fluid and/or attached to a E/O cooled surface. Such a system may be used to supply cooled fluid. For example, the cooled fluid may be used to export the cooling effect to any purpose requiring cool fluid. The result may be a more efficient and/or clean heat exchange process.

In some embodiments, temporal efficiencies of geothermal air-conditioning solutions and other energy generators such as solar based energy generators may be managed to increase efficiency (e.g. improve revenue and/or reduce non-renewable energy use) —A) for example multiple water sources available in the near vicinity may be deployed and/or combined to improve efficiency of heat use and/or distribution B) any, all and/or a subgroup of the following infrastructures may be utilized: geothermal heat transfer, geothermal heat storage, solar energy generators, water heaters and/or other current generators, E/O cooling solutions and/or underground reservoirs. In some embodiments, there may be more than one independent reservoir and/or at least 2 and/or 3 reservoirs where at least one is configured to facilitate efficiency for a cooling system and at least one is configured to facilitate efficiency for a heating system. In some embodiments, the system is configured and/or controlled to facilitate supplying fluid in a preset and/or constant temperature value. For example, the desired temperature may be achieved by mixing fluid from hot and cold fluid sources and controlling the resulted temperature of the stored and/or output fluid.

### Specific Embodiments

Before explaining at least one embodiment of the invention in detail, it is to be understood that the invention is not necessarily limited in its application to the details of construction and the arrangement of the components and/or methods set forth in the following description and/or illustrated in the drawings and/or the Examples. The invention is capable of other embodiments or of being practiced or carried out in various ways.

### System Design

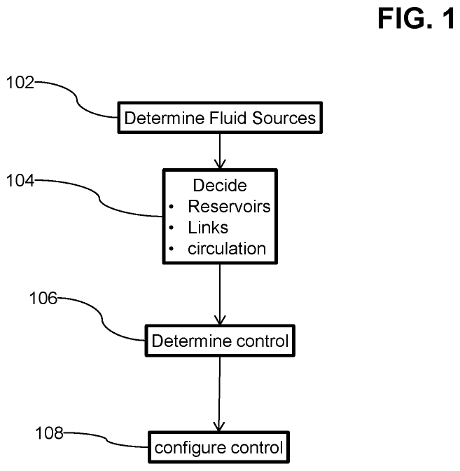

Referring now to the drawings, FIG. 1 illustrates a method of designing a heat management system for in accordance with an embodiment of the current invention. In some embodiments, the planning stage includes determining 102 system components and/or limitations. For example, system components may include available water sources and/or their characteristics (for example temperature, cost, time of availability, quantity etc.) and/or existing system modules and/or planned system modules (for example, geothermal air-conditioning subsystems, solar based hot water sources and/or electric power generators, other energy generators and E/O cooling modules). Limitation may include the types of allowed links between water sources and/or modules, temperature limitations of components, allowed waste flows etc.

In some embodiments, the design stage includes, deciding 104 various physical aspects of the system. For example, it may be decided, the number, capacity, location and/or characteristics of reservoirs. For example, a designer may attempt to determine an efficient set of reservoirs based on system planned output requirements, cost limitations, site and/or ground limitations, and/or existing/planned connectable geothermal, solar energy-based subsystems and/or other energy generators. Optionally, links (inflow and outflow) to public clear, semi-clear and waste water systems per limitations of local regulator and local economic considerations (usage costs) are planned at this stage. In some embodiments, links, circulation routes and/or streaming regimes between the alternative water sources, the heat-pumps used for heat exchange of air-conditioning systems and/or other relevant modules such as heat/electric-power/cooling generators, Based on the planned circulation routes, a valve and/or pipe system and circulation pumps for enabling and/or controlling the streaming and routing regimes.

In some embodiments, designing a system includes determining 104 a control methodology for valves and/or devices in the system. For example, some valve may include local logical control (for example a local controller), some valves may be under direct control of a central controller and/or a regional controller (for example, a certain module and/or sub-system may include a regional controller controlling multiple valves and/or devices) and/or a central controller. Optionally communication channels for updating software and/or routines and/or updating data are planned.

In some embodiments, various decision algorithms for valve, devices and/or for integrated system control are configured 108 (e.g. programs are written and/or adjusted to control opening and closing of valves and/or activation, deactivation of system and/or setting parameters of valves (e.g. how far does it open) and/or system (set thermostats, power levels etc.). Control optionally depends on the relations between various measured and/or controlled parameters, for example sensed temperature values of liquids (for example at sources and/or at various location in the system and/or heat-sinks in the system).

### An Exemplary System

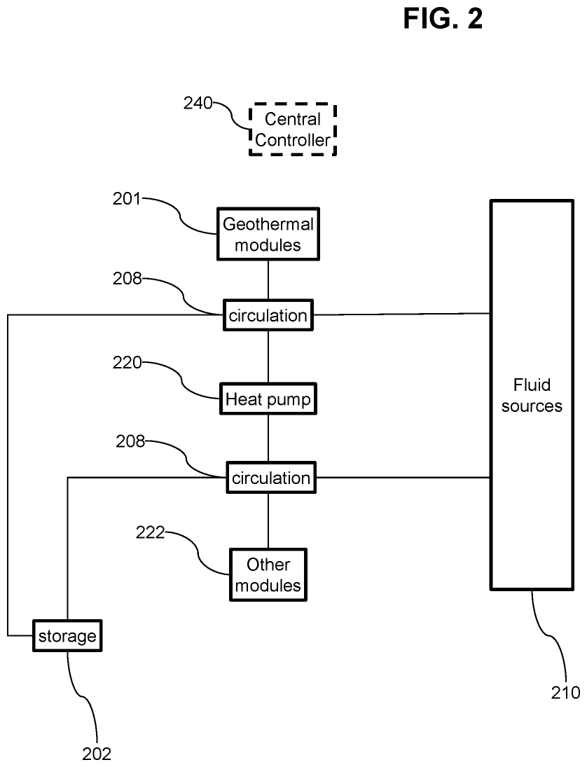

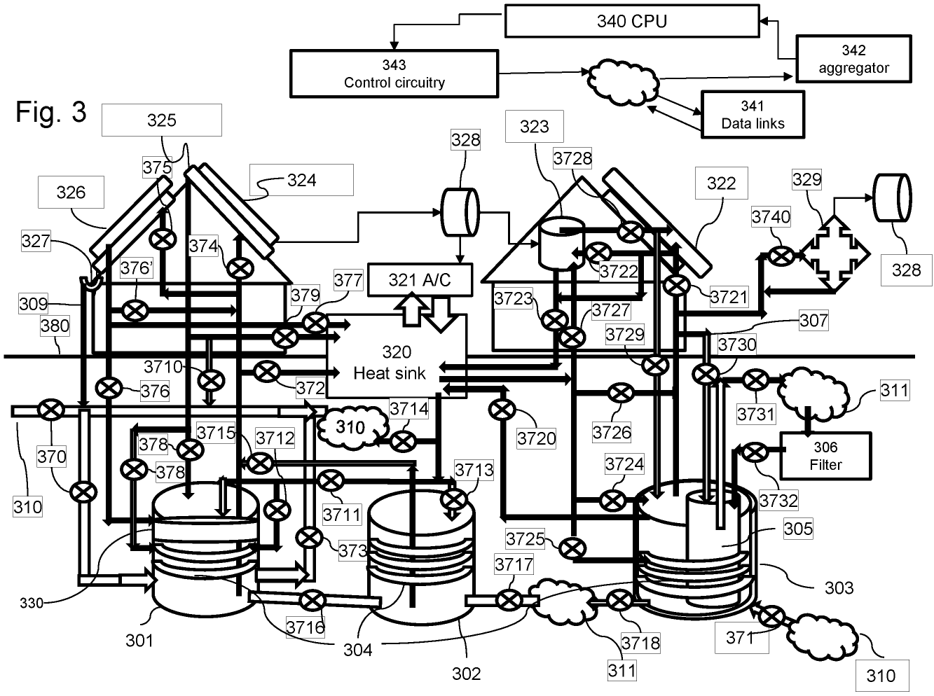

The exemplary systems of FIG. 2 and FIG. 3 are based on design and deployment of subsystems. Optionally, the subsystems may be add-ons to existing deployed systems on a site. For example, additional modules may be installed in connection with or as an upgrade of an existing system, for example to increase performance and/or decrease use of fossil fuels and/or to decrease environmental footprint of an existing system and/or to increase use of “green-energy”. Alternatively or additionally, the system may replace an existing system. Alternatively or additionally, the system may be built new (for example for a new building) The system is optionally modular and/or allows inclusion or exclusion of various modules, connections and/or reservoirs according to available resources and desired capabilities of the system. The system may be planned and/or updated for increasing “green-energy” production by utilizing updatable algorithms for selecting temporal routes for liquids flowing between the system modules for elevating their energy-production efficiency.

In some embodiments, a heat management system is based on a semi-open-loop design. This is in contrast to many conventional air conditioners which are built in a closed loop manner. Optionally, a semi-open-loop design facilitates feeding the heart of the air-conditioning system, a heat-pump, with cold fluid when in “cooling mode” and/or with hot fluid in heating modes.

FIG. 2 is a block diagram of a heat management system in accordance with an embodiment of the current invention. In some embodiments, the system receives fluid from one or more fluid sources 210. Optionally, differential temperature fluid is supplied using “green” energies. For example, hot water may be supplied by heated waste flows and/or cold water may be supplied from incoming municipal water that is being used in the building. Additionally or alternatively, circulation system 208 may include pipes, valves and/or pumps that circulate the fluid. Optionally, the pumps may use conventional (non-green) power and/or they may operate on green-energy, for example solar energy. In some embodiments, a semi-open-loop system facilitates feeding non-geothermal modules 220, 222 of the combined system. For example, a controller 240 will direct circulation to feed a module 222 based on solar energy with fluid flows that improve their efficiencies. For example, fluids from the non-geothermal modules 222, 220 may circulate back into the geothermal part of the system. The controller 240 may use such circulation to achieve performance, (for example, by supplying the colder/hotter fluids at the entrance of the heat pump 220 operating in cooling/heating modes, respectively) the system employs various potential fluid sources 210 available at the specific site of deployment. For simplicity of the following description the term water may be used. The term water may refer to any fluid unless specifically stated otherwise. The term water is used because, in many sites it is the most available fluid. In some embodiments, for example, in certain closed loops of non-water liquids may be used in the system. For example, non water fluids may facilitate achieving better local heat-exchange efficiencies

In some embodiments, a system employs several water sources 210 for achieving its goals. This may achieve improved temperature flows for heating and cooling and/or make available bigger quantities of available water for the system operation, and/or supply water at controlled temperature (for example a preset value of water temperature). The controlled temperature may optionally differ from the long-term static equilibrium of the geothermal conditions. In some embodiments, water is stored in the tank and/or pipe network above-ground and/or underground and/or in reservoirs 202, mainly but not mandatorily underground (ground level 380 is illustrated as a horizontal line if FIG. 3). Underground reservoir 202 is optionally and on-site installation. In some embodiments, (e.g. when regulatory allowed), the reservoir 202 may be connected to public water sources 210. For example, fluid may be used for filling the on-site reservoirs, receiving excess water from the local reservoirs, streaming and exchanging “public” water into/with the local reservoirs, for example, when the central controller 240 determines that relative temporal temperature values of the “public” reservoirs, with respect to the values measured at the local ones, economically justify such exchange.

In some embodiments, connecting solar-energy based modules, and/or other green energy generators, such as wind-energy modules 222 and the geothermal modules 201 and/or reservoirs 202, facilitates feeding the geothermal air-conditioning and/or a heat-pump 220 and/or the local reservoir 202 with hot water which is generated by such green energy heaters. Optionally, the system controller 240 verifies that directing heated water to the geothermal modules 201 will not unduly affect the supply of hot water on-site.

In some embodiments, controller 240 controls the flow of external fluid sources 210 into reservoirs 202 to maintain a water temperature which is close to a preset temperature value. For example, the preset temperature may be defined by a specific end-user of the stored water in the reservoir. The flow control can be either pulsed, and/or continuous and/or a combination of both. The water flow may be changed based on a change of the stored water temperature by a given increment, and/or the availability of external sources having an appropriate fluid temperature. An example for such an end-user, requiring water at a preset temperature, which might be different than the geothermal equilibrium, includes an irrigation system, designed for watering of certain crops, where the preset watering temperature is dependent on season, growing conditions and age of the watered plants. For example, growth and/or health and/or productivity of the plants may be increased by supplying a desired temperature of water.

In some embodiments, the controller 240 will direct locally stored cool “geothermal” water for cooling the heat-sinks of local solar electricity generator, e.g. PV panels (for example in module 222). Alternatively or additionally, the controller 240 will direct flow of relatively warm stored water into the heat-sinks of E/O cooling devices (for example in modules 222) and then stream the outcoming flows either directly to the heat-pump 220 and/or back into the local reservoir 202. In some embodiments, the system generates higher efficiency of solar electricity production coupled with hotter/cooler input flow at the heat-pump, operating in heating/cooling modes, respectively.

FIG. 3 is a schematic illustration of a heat management system in accordance with an embodiment of the current invention. The system of FIG. 3 has a large number of optional components, an actual system may include all the illustrated element or a portion thereof and/or other elements as determined for the local situation.

### Geothermal Modules:

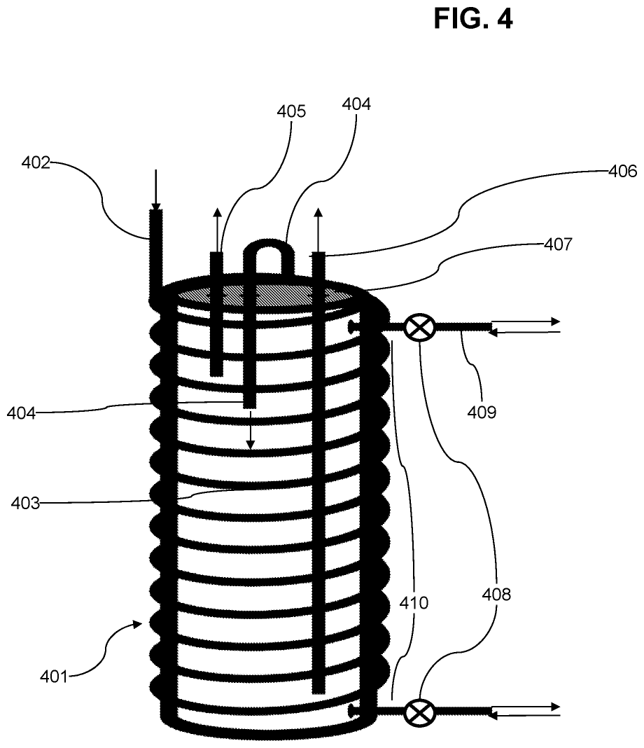

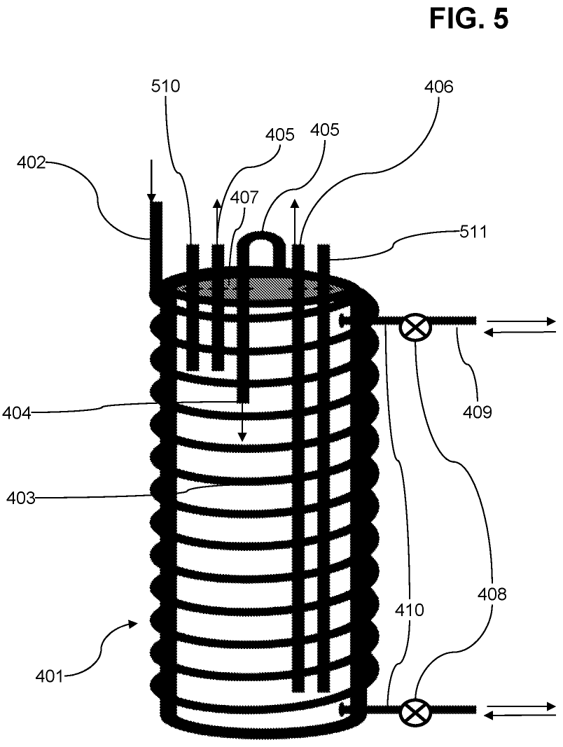

The exemplary geothermal grid, as presented in FIG. 3, includes for example:
i. Heat-exchanger—In some embodiments a heat management system may include a heat exchanger 320 optionally including a circulation-pump. For example, the heat exchanger 320 may be fed by locally controlled stored water in either heating or cooling modes. For example, the heat exchanger 320 may be used for heat exchange by a heat pump and/or an air-conditioning system 321.
ii. Reservoirs—The system optionally includes one or more local (on-site) underground and/or aboveground storage reservoirs. A reservoir optionally includes a pipe system as included in conventional geothermal systems. Optionally, underground tanks which can store the required amount of water for all system modes and applications as presented below.
iii. Tanks—In some embodiments, a heat management system includes one or more tanks. Optionally, a reservoir may include multiple tanks are connectable yet independent. Alternatively or additionally, a reservoir may include a single tank and/or multiple independent tanks. For the sake of simpler description of both cooling and heating modes of the system, FIG. 3 presents an exemplary case that includes 3 tanks, but it should be underlined that the functionality of the 3-tank description may be merged into a single tank. For example, a single tank may be used for heating or cooling purposes as dictated by the route control of water in the combined solution. In some embodiments, a multi-reservoir system facilitates 1) the option to switch between reservoirs when a faster temperature equilibrium with the surrounding ground is desired and/or 2) the option to adjust design of at least one reservoir for cooling mode and at least one other reservoir for heating mode, e.g. by selecting proper insulation materials internal and/or external to the tanks, particularly when there are usable water sources in the semi-open system that are colder/hotter than water stored in a geothermal equilibrium underground, and their exploitation improves the system efficiency (when compared to the use of water in geothermal-equilibrium).
   Exemplary tanks 301 and 302 are presented for clarifying the cooling modes of the solution. For example, tanks 301 and/or 302 may include the design elements illustrated in FIGS. 4 and/or 5.
   Exemplary tank 303 is presented for clarifying the heating modes of the solution. For example, tank 303 may include the design elements illustrated in FIGS. 5 and/or 6. Tanks 301, 302 and 303 may be designed to be pure tanks containing a selected quantity of water for exchanging heat with the ground. Alternatively or additionally, tanks 301, 302, 303 may include a heat exchanger supplying heat exchange between an inlet of the tank 301, 302, 303 and the ground. For example, the heat exchanger may include a high surface pipe 304. For example, pipe 304 may meander and/or surround and/or helically wind around a tank 301, 302, 303. In some embodiments, a high surface pipe 304 facilitates faster exchange of heat with the ground is required. The pipe 304 may be combined with and/or designed as part of the tank. In some embodiments, designing tank 301, 302, 303 and pipe 304 together may improve ease of construction and/or deployment. Alternatively or additionally, a high surface area pipe may be designed and/or installed independently of the tanks, for example, when the system is deployed as an upgrade of an existing geothermal solution.
   In some embodiments, a tank 303 includes internally additional reservoir in a form of a tank 305 and/or a pipe module which is sealed from tank 303. Optionally tank 305 contains filtered waste water. For example, warm waste water may be circulated through tank 305 for the purpose of warming water in tank 303 water above the geothermal equilibrium temperature. Optionally, an insulating layer interposes between tank 303 and the ground. For example, insulation may preserve water in tank 303 at temperatures above equilibrium temperature of the ground. Additionally or alternatively, insulation may be useful when tank 303 is fed by other warm water sources, such as, solar water heaters.
iv. Water sources—In some embodiments, a heat management system may be connected to one or more employable water sources. For example, the external water sources may include a connection 310 to a public water supply. For example, the public water supply may include clean water (e.g. treated drinking water and/or deep well water) and/or semi clean water (e.g. water from a surface source such as a lake, pond and/or river). Alternatively or additionally, water sources may include rain water collected by gutter systems 309, or public waste water 311 and/or private waste water 307. For example, the waste water may be passed through a treatment system (optionally on-site and/or part of the public system (for example, the treatment system may include a filter 306)). Additionally or alternatively, waste water may be treated while being streamed into tank/pipe system internal to tank 305.
   In some embodiments, water from public reservoirs may be used for initial filling of the local tanks 301, 302, 303 and/or for refilling the tanks 301, 302, 303, for example, when the semi-open loop facilitates “discharging” water. Discharging water may be performed when it is economically beneficial for the operation. Alternatively or additionally, public water may be used directly and/or to affect the local reservoir water temperature. For example, direct use of water sources may occur when the public reservoir or rain water temperature is significantly higher/lower than the temperature of the water in the local reservoirs. For example, an algorithm on a central controller 340 and/or a regional controller and/or a local controller may automatically use the valve system for exploiting the temperature difference (for example, when regulatory allowed and/or when the use contributes economically to the green energy production). The treated waste water is optionally used for indirectly affecting the local reservoir water temperature (e.g. waste water passes into tank 305 and/or heat is transferred between tank 305 and tank 303). Alternatively or additional, a connection to waste water may use for disposal of excess water from the semi-open-loop. Alternatively or additionally, excess water may be streamed back into the clean and/or semi-clean public reservoirs.
v. Internal heat sources/sinks—In some embodiments, local sources of heat and/or cooling may be used to heat or cool fluid. Optionally, a semi-open-loop system may use water sources which change their temperature through heat exchange other than ground based geothermal solutions. For example, internal heat source may include a module in the system which receives water from the pipe network and/or generates a temperature gradient between the water streamed into and out of that module. The flow rate and/or temperature may depend on the water temperature outflowing from the non-geothermal reservoirs and/or depending on the system mode (heating, cooling, and/or stabilizing stored water temperature on a preset temperature value) and/or depending on the total available flux of water and/or heat generated by such sources, the water flowing to/from the geothermal reservoirs and/or such internal water sources. For example, internal heat sources may include. solar-water heaters 322 and/or a related above ground tanks 323, solar PV panels 324 and/or their heat-sinks 325, E/O cooling modules 326 and/or their heat sinks, and/or other green energy generators 329. Fluid may be automatically directed to one or more of the internal heat sources simultaneously. For example, fluid may be directed directly from the internal sources to a heat exchanger 320 of a heat pump. For example, fluid passing through an internal heat source may be used when the source temperature is superior to the geothermal reservoir temperature (mode dependent). Alternatively or additionally, fluid passing through the internal source may be directed into the geothermal reservoirs—when the source temperature is superior to the geothermal reservoir temperature and/or the flux is stronger than currently needed by the heat exchanger 320. Alternatively or additionally, fluid from the local heat source may be brought back to equilibrium with the ground and/or the ambient atmosphere when the temperature of the water in inferior to the ground and/or the atmosphere (for example, hot water when the system is in cooling mode and/or cold water when the system in heating mode). For example, water may be circulated to a geothermal reservoir through a high surface area pipe (e.g. spiral surrounding pipe subsystem, 304) before streaming into the tank 301, 302, 303. Alternatively or additionally, water may be sent to an above ground reservoir. Alternatively or additionally, water may be sent to a public water reservoir 310 and/or to waste 311, for example, when temperature difference between the internal source, the geothermal reservoir and other modules in the system and the system mode does not economically justify circulating the water internally.
vi. Pipes and valves—In some embodiments, a heat management system includes a circulation system. For example, the circulation system may include pipes, valves and/or one or more controllers with sensors to select routing of water between modules. For example, water may be routed into the heat exchanger 320 or a solar based energy production module. Optionally, routing is managed utilizing a circulation pumps and a network of pipes and automatic valves connecting components.
   1) In some embodiments, alternative routes may be designed for control of heat transfer. For example, flow to or from an on-site geothermal reservoir may be direct and/or indirectly (e.g. utilizing high surface area pipes, for example surrounding helical pipes 304 or in tank/pipes such as 305). In some embodiments, the circulatory module includes pipes connecting the geothermal reservoirs or the internal water sources to the heat-sink.

### Other Modules:

In some embodiments, non-geothermal system modules may include subsystems that are pre-installed on-site and/or added as part of upgrading a heat management system. For example, a local “green-energy” production system may be upgraded and/or connected, through circulated fluid to and from a geothermal system. In some embodiments, these upgrades may significantly contribute to the entire system efficiency. FIG. 3 includes several examples to such modules which are listed below. In some embodiments, other energy related modules (green and/or conventional technology) may be integrated to a geothermal system. Optionally, modules producing heat, absorbing heat and/or having temperature-dependent efficiency may be modularly added to the system. For example, the modules may be connected via pipes and/or valves circulating fluid through the network. For example, a controller 340 of the system may identify availability and/or demand for cooling or heating water streams. The controller 340 may direct available heat or cooling to modules that will benefit from the flow. In some embodiments, the system may directly improve its efficiency or gain from the removed heat generated by such module which can be transported into the reservoirs.

### Exemplary NON-Geothermal Modules Presented in FIG. 3, Include:

vii. Solar based water heaters 322 and related above ground tanks 323—In some jurisdictions solar based water heaters (e.g. heater 322) are legally required as part of the roof of each new building. In some embodiments, the solar water heaters 322 generate hot water during day-time. The water may be stored through passive circulation in insulated tanks 323 that are placed either on the roof or below it. In some embodiments, the circulation of water from the heaters 322 into the tanks 323 is based on temperature gradients. Once the water temperature in the tank 323 reaches the values in the heater 322 the circulation may be reduced. In some cases, flow is mechanically stopped due to temperature related safety issues. In some cases, the hot water production capability of the installed modules is not fully employed. Some embodiments of the proposed system present alternative modes of utilizing the excess solar-heated water, beyond the safe capacity of above ground dedicated tanks. Additionally or alternatively, some embodiments of the proposed system may elevate the solar water heating efficiency.
   In some embodiments, excess solar heated water is directed by the pipes and valves network of the system directly into the heat-exchanger 320, for example, when the system is in heating mode and/or day time. Alternatively or additionally, excess solar heated water is directed to storage for later use. For example, storage may include an underground reservoir (e.g. tank 303). Alternatively or additionally, when the water temperature at the public network is lower than that of the water in the underground tank 301, 302, 303 water may be routed to the water to heater from the geothermal reservoirs (e.g. tank 303). Rerouting warm geothermal to the solar heater 322 optionally reduces the time for the solar heater 322 to reach higher water temperatures and/or freezing of the water at the heater pipes is avoided.
   In some embodiments, other “green energy” producers may be connected to the heat management system (e.g. generators 329) which can include for example a wind-power generator requiring defrosting of its blades, the solar heated water may be streamed to such target either directly or through intermediation of the storage at the underground reservoirs 303.
viii. Solar electric power generator and/or associated heat-sink—In some embodiments, solar electric power generator 324 and/or heat-sink 325 is connected to the proposed system. For example, fluid from the system may be used for reducing the temperature of the solar-current producing modules (e.g. PV panels). For example, the cooling may utilize water cooled heat-sinks. Optionally, cooling the current producing modules results in higher efficiency of the relevant modules (e.g. higher electric power per unit of solar radiation flux). Depending on the temperature of the water flowing out of the heat-sinks 325 and the system operational mode (heating/cooling/idle) the routing of the water outflowing from the heat sink may be directed, for example, into the geothermal heat-exchanger 320 (e.g. when the system is in heating mode). For example, this may increase heating efficiency when the temperature of heat sink 325 is higher than that of alternative warm water sources in the system. Alternatively or additionally, cooling fluid from the solar electric system from heat sink 325 may be directed back into geothermal tanks 301, 302, 303. Optionally, water is routed through the high surface area pipes 304 or directly into the tanks depending for example on equilibrium rate required. Alternatively or additionally, for example when allowed and economically justified, fluid and/or waste heat from the solar electric module heat sink 325 may be sent into the public reservoirs 310.
ix. E/O cooling system and associated heat sinks—In some embodiments, a E/O cooling system 326 and an associated heat sink is connected to the proposed system. For example, the E/O system 326 may be used for further reducing the temperature of the water stored in the geothermal reservoir. Optionally, flow is routed from the geothermal tank 301, 302 into the E/O cooler 326 heat sinks. For example, the outflowing stream, may be cooled by few degrees C. The resulting flow may be routed directly into heat-exchanger 320 (e.g. when in cooling mode). Alternatively or additionally, water from the E/O system 326 may be routed into the heat sinks of the solar current generator 325. For example, this may elevate efficiency of generator 325. Alternatively or additionally, water from the E/O system 326 may be routed into the geothermal reservoirs, 301, 302, 303, for example, when their temperature should be lower (in cooling mode) and/or a combination of part or all the above, depending on the available flux (moderated by the system algorithms).
x. Non-Solar “green energy” generator—In some embodiments, a non-Solar “green energy” generator 329 may be connected to streaming the water out of a geothermal tank 301, 302, 303 or the solar-based modules into them. For example—some wind energy conversion systems that are based on blades or equivalent mechanisms that are put in motion by the wind, do not operate properly near and below freezing ambient temperatures. In some embodiments, warming such modules by water having temperatures at geothermal equilibrium or higher may improve the efficiency of such wind-based power generators. Optionally, the system may be fully and/or partially self supporting. For example, power for the processor and/or sensors and/or actuators (e.g. automatic valves) may be supplied partially and/or completely by modules of the system itself (e.g. solar generated electricity and/or wind generated electricity).
xi. Circulation network:

In some embodiments, heat transfer between modules is achieved by the circulation of fluid between the modules. For example, water may be circulated in pipes and/or controlled by valves. For example, the valves are optionally controlled by local controllers and/or a central controller. For example, water may circulate through a network of pipes connecting the modules included in the system. Optionally, automatic valves open and/or block a specific route for streaming water between alternative routes. For example, the selected routes may be mode dependent (different routes may be used for heating and cooling modes and/or for different temperature distributions of the network and/or for different available flow rates). Optionally, one or more circulation pumps drive the flow in the pipes in a selected direction. Optionally, valves may be controlled by a local controller and/or by a regional controller and/or centrally controlled by a central control module 340. receiving and transmitting data through a wired or wireless links 341. Optionally, an aggregator 342 aggregates temperature values from different parts of the system and/or transfers data to the central processor 340. In some embodiments, control circuitry 343 generates and/or sends control commands to the valves and pumps. For example, control circuitry 343 may generate valve commands with preset algorithms in response to instructions from the central processor 340. Optionally, commands are relayed through the links 341.

In some embodiments, a circulation network may include 2-way valves. For example, valves are installed on specific segments of the pipe network. Optionally, algorithms controlling flow may select a single streaming option out of 3 or 4 alternatives and/or the option may be selected for a fixed period and/or until a change in the relative temperature values is measured in the system. In some embodiments, the use of 3-way or even 4-way valves may reduce the number of system components and/or the complexity of the algorithms defining the selected liquid routing. In some embodiments, a system may use valves to open more than single route flowing from the same source, simultaneously. To facilitate multiple routes in may be advantageous to include a large number of 2-way valves rather than a smaller number of 3- or 4-way valves. Opening multiple routes from a single source might be found beneficial in some embodiments under certain temperature regimes and/or available water capacity conditions.

In the exemplary embodiment of FIG. 3, for convenience, collocated valves and sensors are marked as a single unit with a shared marker. In some embodiments, a valve and a sensor may be packaged as a single unit and/or communicate as a single unit. Alternatively or additionally, a valve may be packaged and/or controlled separately from any particular sensor and/or a sensor may be packaged and/or controlled separately from any particular valve. Optionally, communication means, wired or wireless, may support the transfer of sensors' data from sensors and/or commands to valves. Alternatively or additionally, each of a valve and a sensor may include a different communication interface.

In some embodiments, reducing the number of reservoirs, for example using a single underground reservoir for both—heating and cooling modes reduces the number of valves. On the other hand, linking more independent reservoirs to the system and/or including more valves may facilitate more efficient selection of the liquid routing.

The exemplary embodiment of FIG. 3 includes a number of valves. Optionally, some of the valves and/or some their functions for which they may be used are listed below:
xii. Valve 370 and/or valve 371—are optionally used for filling the underground (UG) water tanks 301 and 303, respectively, with clean or semi-clean water from the public network 310 and/or local rain water collection by gutter systems 327. Valve 370 and valve 371 are optionally opened once the setup of the system is completed and/or when the algorithms allow discharge of water from the system into the public water systems 310 and/or refilling of tanks 301, 302 and/or 303.
xiii. Valve 372—is optionally used for streaming fluid from the geothermal reservoir (e.g. tank 301) into the heat-exchanger 320 of the air-conditioning system.
xiv. Valve 373—is optionally used for discharging water from one or more tank 301, 302, 303 into the public clean or semi-clean water system 310 (e.g. when regulations allow).
xv. Valve 374—is optionally used for streaming of geothermal water for cooling solar-based electric energy generator (e.g. heat-sinks of PV panels of module 322).
xvi. Valve 375—is optionally used for streaming of geothermal water to be cooled by the E/O cooling module 326,
xvii. Valve 376′, valve 376 and/or valve 377 is optionally used for the streaming of E/O cooled water for cooling heat-sinks 325 of PV panels 324. Alternatively or additional, valve 376′ may stream E/O cooled water and/or valve 376 may stream geothermal cooled water and/or valve 377 for streaming water into the feed of the heat exchanger 320 (e.g. in cooling mode).
xviii. Valve 378′ and/or valve 378—is optionally used for routing outflow from the PV panels 324 and/or heat-sinks 325 into the high surface area pipes 304 of tank 301 (e.g. valve 378′) (e.g. when water requires fast geothermal cooling). Alternatively or additionally, valve 378—is used for routing outflow from the PV panels 324 and/or heat-sinks 325 directly into tank 301.
xix. Valve 379—is optionally used (e.g. when the system is in heating mode) for routing the outflow from the PV panels 324 heat-sinks 325 into the feed of heat-exchanger 320 when the temperature of the outflow is superior to alternative sources,
xx. Valve 3710—is optionally used for discharging outflow from the PV panels 324 heat-sinks 325 into the public water system 310 (e.g. when economically plausible and regulatory allowed).
xxi. Valve 3711, valve 3712, valve 3713 and/or valve 3714—is optionally used for routing of water returning from the heat exchanger 320 when operated in cooling mode. For example, valve 3711 facilitates streaming the water into the geothermal tanks 301, 302. For example, valve 3712 facilitates streaming into the high surface area pipes 304, (e.g. when fast cooling is desired). For example, valve 3713 facilitates streaming into only one of tanks 301, 302 (e.g. whichever is temporarily less active as a geothermal source). For example, valve 3714 facilitates streaming into the public network 310, (e.g. when allowed). Opening or blocking the valves depends on, for example, the measured temperature values of water in different sources and the decision algorithms set for the system.
xxii. Valve 3715—is optionally used for connecting of geothermal water from an adjacent independent tank 302 (e.g. for assisting or replacing tank 301) (FIG. 1 presents one extra tank, tank 302; alternatively or additionally the system may support any number of reservoirs depending on the heating and/or cooling requirements).
xxiii. Valve 3716—is optionally used for streaming water between adjacent reservoirs (for example, tank 301 and tank 302). For example, streaming water between tanks may be used in cases where not all reservoirs are connected to the public network 310 and/or when one or more tank 301, 302 may be emptied and others can absorb the outflow of water and/or when geothermal reasons justify the transfer to and/or when mixing is desired between adjacent tanks.
xxiv. valve 3717 and valve 3718—is optionally used for discharging the reservoirs' 301, 302, 303 water into a public waste water system 311.
xxv. Valve 3720—is optionally used for streaming water from geothermal reservoir (e.g. tank 303) into the feed (e.g. during heating mode) of heat-exchanger 320 of the geothermal air-conditioning system.
xxvi. Valve 3721—is optionally used for streaming water from geothermal reservoir (e.g. tank 303) into the feed of the solar-based water heating system 322, e.g. for further warming of the geothermal water.
xxvii. Valve 3722 and valve 3723—is optionally used for streaming of the solar-heated water for example into the above ground hot-water storage tank 323 (e.g. through valve 3722) and/or into the feed (e.g. during heating mode) of the heat-exchanger 320, or directly into a heat pump (e.g. through valve 3723).
xxviii. Valve 3724, valve 3725, valve 3726 and/or valve 3727—is optionally used for routing of the relatively cooler output from the heat-exchanger 320 (e.g. during heating mode) into alternative targets in the system. For example, into the geothermal reservoir (e.g. tank 303, through valve 3724), and/or into the high surface area pipes 304 connected to tank 303 (e.g. through valve 3725), and/or back into the solar heating system 322 (through valve 3726) or into the above ground hot water tank (through valve 3727).
xxix. Valve 3728—is optionally used for streaming from the above ground hot-water tank 323 into the solar based water heating module 322.
xxx. Valve 3729—is optionally used for streaming of excess hot water from the above ground hot water tank 323 and/or the solar based heater 322 into the geothermal tank 303 for a later use.
xxxi. valve 3730—is optionally used for streaming of warm and/or filtered waste water into a sealed module (e.g. tank or pipes 305, internal to tank 303). For example, warm waste water may be used for elevating the temperature of the water stored in tank 303. In some embodiments, insulation of tank 303 may be used, for example when tank 303 is dedicated for heating modes of the system for expanding the temporal effect of the warm waste water on the temporal temperature of the stored water.
xxxii. Valve 3731—is optionally used for streaming the waste water from tank 305 into the public waste water system 311. For example, discarding of water from tank 305 may facilitate further streaming of newly warmed waste water, for example, when the temperature of the water in tank 305 decreases.
xxxiii. Valve 3732—is optionally used for streaming waste water from a public treatment system (e.g. filter 306) which is regulated for use in geothermal systems.
xxxiv. Valve 3740—is optionally used for streaming of warm geothermal water into non-solar based green-energy generators 329 (e.g. for winter warming the blades of wind-based electricity power generator). Optionally, the streamed water circulates internal to the target and flow back into the geothermal tank 303.

### Water Temperature Control and Flow Control:

In some embodiments, the proposed system is to improve the temperature of water streamed into temperature sensitive modules of the system. For example, to the heat-exchanger 320 of a heat pump of the geothermal air-conditioning system. In the case of the heat-pump 320—improved temperature means for example, hotter water when in heating mode and/or colder water when in cooling mode. Additionally or alternatively, the system may be configured to reduce possible investment of “non-green” energies during the streaming process.

For selecting the route of water feeding the heat pump several optional actions are built-in the system. Some of the actions are mode-dependent (e.g. some are performed in the heating mode and/or others in the cooling mode and/or others in temperature stabilizing mode). In some embodiments, the actions are selected by an automatic algorithm. Data used for making decisions by the control system may include temperature values, for example water temperature at different parts of the system.

In some embodiments, a system for controlling the valves includes a local control. For example, the local control may depend on the temperature gradient of the water on two sides of a specific valve. The following are few examples where a simple system may be operated using locally managed algorithms (i.e. without mandatory usage of the central control system 340 and its immediate accessories) —

1) For example, when the air-conditioning system is in “heating mode” and the temperature of usable water reservoirs 323 connected to the solar water heaters 322 is much higher than the temperature of the water stored in the geothermal tank 303, then based on the temperature gradients around valves valve 3721 valve 3720 may be closed and/or to opened. The circulation will optionally facilitate the hot water to move either directly from the solar heaters into the heat-exchanger 320 and/or through the intermediation of the hot-water tank 323 (e.g. by opening valve 3722). Additionally or alternatively, When the temperature on the solar side of valve 3721 is lower that the geothermal side, e.g. in night time, valve 3721 is blocked and valve 3720 is opened.

In some embodiments, routing of the water returning from the heat-exchanger 320 may be managed by the temperature gradient around valve 3724. For example, in day time, when the returning water is much warmer than the water in the geothermal reservoir 103, the control optionally blocks valve 3724 and valve 3725. For example, this may result in immediate efficient use of the water through further solar heating and circulation into the heat-exchanger 320 (e.g. by opening valve 3726). Alternatively or additionally, when the above ground tank 323 is hot and/or in equilibrium with the heater 322, valve 3727 is opened. However, when the returning water is warmer than the geothermal water (e.g. in day) valve 3725, valve 3726 and/or valve 3727 may be blocked and/or valve 3724 is opened to warm up the reservoir. Additionally or alternatively, when the returning water is colder then geothermal tank 303, valve 3724, valve 3726 and valve 3727 may be blocked while valve 3725 is opened to reduce the effect of the returning cold water on the tank 303.

2) In some embodiments, for example when the heat-pump is in cooling mode and/or the E/O cooling module is part of the system, when the temperature gradient on valve 375 shows that the water at the cooling system is cooler than the geothermal water, the control opens valve 375 and/or valve 377 and/or blocks the feed to the heat-exchanger 320 through valve 372. The returning water from the heat pump in this case are managed by the gradient on valve 3711. When the returning water is colder than the tank 301, 302 valve 3711 is open and the water cool the geothermal tank 301, 302. Additionally or alternatively, when the returning water is warmer than the tank 301, 302, depending on the gradient value on valve 3711 and/or the available modules in the system, valve 3711 is blocked and the routing is to the high surface area pipes 304 (e.g. through valve 3712), and/or to inactive tank 302 through valve 3713 and/or the routing is to the public network 310 where valve 3714 is open.

In some embodiments, a centralized control 340 can manage algorithms by taking into consideration temperature gradients and/or other considerations. For example, other considerations may include more complicated thermodynamic data including for example the heat capacity of the reservoirs, knowing the water volume in them, the temporal change in temperatures of each water-source with inflow of stream from a different source, the systematic behavior of solar energy based modules, the changing temporal input power as expected for the air-conditioned building with time of the day and/or weather forecast data (for example automatically accessed through the Internet). By processing various sources of data together with the temperatures (which are optionally sensed continuously), central controller 340, managing the water routing may improve the temporal input to heat exchanger 320 and/or other system modules. Additionally or alternatively, controller 340 may take into consideration long-term management of the tanks 301, 302, 303, 305 and their interaction with public water sources 310, 311. Such advanced algorithms may maintain a few routes open in parallel and/or when the system is based on advanced valves which include few “open” levels, the algorithms can even quantitatively split the available stream between the routes that are open in parallel.

In some embodiments, the control of a system will be centralized for example, based on online processing of data. Processing may be accomplished using artificial intelligence (AI) and/or algorithms for flexible water routing management. Optionally the system includes communication between controller 234 and the distributed temperature sensors and/or the network of valves.

Optionally the communication network built is through wired links running side by side and/or physically connected to the networks of pipes and reservoirs on which sensors and valves are placed. Several existing protocols and off-the-shelf hardware components can support the required communication data to be implemented for example, the communication routines may reside in a data link module 341.

Optionally central controller 340 includes programmable logic controller which is designed to manage communication to and from the sensors and/or valves. In some embodiments, the activation of algorithms and/or their outgoing commands to the valves include customization for a specific site. The customization may include receiving system data, including connected modules—geothermal, solar-energy based and/or others, and their physical properties, the network of valves and sensors, the characteristics of the air-conditioned buildings and/or the characteristics of the deployment site, and/or the characteristics of the end-user or application using the flowable fluid in the system. Such input can be in a form of an interface table.

### Other System Modules:

In some embodiments, an underground tank 301 may be designed for a multiple use of its volume, for example by adding one or more fixed and/or floating covers 330. For example, the floating cover 330 may split tank volume into more than a single space Optionally a multi-space tank 301 may be designed for improved geothermal functionality, for example, through allocating different task to each independent space resulting with improved heat-exchange processes and better system efficiency. For example, non-geothermal uses may be assigned to some of the spaces of the tank, including the option of emptying certain spaces of the tank from liquid for enabling such other uses and/or adding access to certain spaces from an external volume, including, if needed, an access of human beings, and/or property for an extended stay in such space.

### Designs of an Underground Storage Reservoir:

FIGS. 4-7 present several examples for alternative configurations of an underground storage tank systems in accordance with embodiments of the current invention. In some embodiments, the selected configuration of the tank depends on alternative water sources which are available. In some embodiments, a tank configuration may combine components that are presented in some different FIGS. and/or include other components and/or leave out some components, internal or external to the tank, Optionally, the system is designed to improve the water temperature and/or quality, for achieving a more efficient use of the stored water.

FIG. 4 is a schematic illustration of a tank in accordance with an embodiment of the current invention. In some embodiments, fluid circulated out of a heat-pump towards the tank 401 thorough an inlet 402 to a high surface area pipe 403. Optionally, a heat exchanger runs around an outer shell of the tank. For example, the heat exchanger may be connected to an inlet to the tank. For example, a pipe 403 runs along the outer shell of the tank. For example, running pipe 403 around the outer shell of the tank 401 may facilitate efficient heat transfer between the water in the pipe 403 and the ground. For example, pipe 403 may spiral around the outer shell of tank 401. Optionally, contact between pipe 403 and the ground facilitates warming the incoming water (e.g. in the winter when the ground is warmer than the outside air and/or when in heating mode). Additionally or alternatively, contact between pipe 403 and the ground facilitates cooling the incoming water (e.g. in the summer when the ground is cooler than the outside air and/or when in cooling mode). Optionally, water passes through high surface area pipe 403 before being injected through an entrance pipe 404 into the tank for storage.

In some embodiments, temperature gradients internal to a tank might be generated during operation, for example while the water temperature in the tank fluctuates around geothermal equilibrium with the ground. In some embodiments, water at an upper level of the tank is warmer than water near the bottom level. In some embodiments, water circulating out of the tank will be streamed through a warm water extraction pipe 405 from an upper portion of the tank 401 when hot water is desired (e.g. in heating mode) utilizing the slightly warmer water at the top of the tank. Additionally or alternatively, water circulating out of the tank will be streamed through a cold-water extraction pipe 406 from a lower portion of the tank when colder water is desired (e.g. in cooling mode) utilizing the slightly cooler water at the bottom of the tank.

In some embodiment, some or all pipes that are designed for streaming water into or out of the tank can reach its inner space through a sealed removable cover 407 (for example as illustrated with pipes 402, 404, 405 and 406). For example, the cover 407 may be designed to simplify maintenance and/or integration issues. Alternatively, some or all of the pipes may pass through the tank's outer shell (for example as illustrated in pipe 410). Pipe 410 is optionally configured to facilitate streaming of water into or out of the tank 401 for example for filling purposes and/or for releasing excess water, and/or for using the tank's water for other “non-geothermal” uses, including emergency water supply when local water infrastructure is out of use. Alternatively or additionally, tank cover 407 may be designed as a “floating cover” enabling split usage of the tank between energy storage and other non-geothermal applications.

In some embodiments, electrical valves 408 on pipe 410 or another pipe connected to the tank (e.g. pipes 402, 404, 405, 406) facilitate switching the stream on/off remotely per system usage. An optional treatment system (e.g. a filter 409) connected to pipe 410 and/or to any other pipe (402, 404, 405, 406) may be usable for controlling the quality of the water inserted into or taken out of the tank. The specifications of the treatment system may depend on the requirement of the modules or applications utilizing the tank water and/or the quality of input water.

FIG. 5 is a schematic view of a geothermal reservoir including extra inlet pipes in accordance with an embodiment of the present invention. For example, inlet pipes 510 and 511 may facilitate an increase in water temperature above a geothermal equilibrium when higher temperature water is desired, for example in heating mode and/or may facilitate decrease of the stored water temperature below the geothermal equilibrium when colder temperatures are desired, for example when operating in cooling mode. For example, a non-geothermal water sources such as solar water heaters in heating mode may supply water at a desired elevated temperature above the geothermal equilibrium temperature. Alternatively or additionally, an E/O water cooler may supply desired cold water below the geothermal equilibrium temperature for example when the system is in cooling modes. Optionally, the hot water is directly streamed into the tank 401 through pipe 510 in heating mode and/or cold water is streamed directly into the tank 401 through pipe 511 in cooling mode. In some embodiments, water at a desired temperature not in geothermal equilibrium is injected directly with reduced heat transfer with the ground (e.g. avoiding the external high surface area inlet pipe 403, 404). In some embodiments, tank 401 may be insulated from the ground (e.g. when water source supplies water at a temperature more desirable than geothermal equilibrium). For example, insulation may reduce the rate of heat transfer into the ground and resulting with a longer availability of the warmer/colder water and a more efficient use of the geothermal system and/or heat-pump combination. In some embodiments, pipes 510 and/or 511 may be configured for generating an increased gradient of temperature in the tank. For example, pipe 510 may inject hot water into an upper portion of the tank 401. For example, pipe 511 may inject cold water into a lower portion of the tank 401. Optionally, this may increase the advantage of extracting the water out of the tank in heating/cooling modes through pipes 405 and 406 to take advantage of the internal temperature gradient in the tank. In some cases, (for example, when the non-geothermal water sources are temporarily unavailable (e.g. at night when solar water heaters are out of use) and/or when the water temperature coming out of the heat pump are less preferable than the geothermal equilibrium temperature (e.g. colder then geothermal equilibrium in heating mode and/or warmer than the geothermal equilibrium in cooling mode), the circulation of the water between the heat-pump and the tank may be switched back to the high surface area inlet pipe 403. For example, pipe 403 facilitates inputting water to tank 401 at a temperature closer to geothermal equilibrium than a direct inlet (e.g. pipes 510, 511).

FIGS. 6 and 7 are schematic illustrations of geothermal reservoirs for use with multiple streams of separate fluids in accordance with embodiments of the current invention. For example, external fluid sources having a desired temperature over the geothermal equilibrium may be used to heat and/or cool water in tank 401. Water from the external source is optionally completely isolated from the water stored in the reservoir 401 of the geothermal system. The two configurations show two alternative modes of heat transfer between the external sources and the reservoir. For example, in FIG. 6 illustrates an exemplary sealed pipe 612, internal to the tank, 401 has an entry 611 and exit 610 penetration through the sealed removable cover 407. For example, FIG. 7 illustrates an exemplary tank 712 within a tank 401. The internal tank 712 is optionally fed through entry 711 and exit 710 pipes penetrating the sealed removable cover 407.

The configuration of FIG. 6 is optionally used for heat transfer to/from a constantly flowing, external source (e.g. use of water from a public water system characterized by a temperature which is much lower/higher than the equilibrium temperature underground in cooling/heating mode, respectively). In this case, the longer the internal sealed pipe the higher the efficiency of the heat transfer from the external source to the stored water.

The configuration of FIG. 7 is optionally used for a heat transfer to/from a pulsed (not constantly flowing) external source characterized by limited amount of water per-pulse (e.g. the use of grey-waste-water originated from filtered sources such as showers/bath, washing machines, dish-washers, etc., in heating mode), where the tank within a tank facilitates optimal use of the isolated water.

In both cases (FIG. 6 and FIG. 7) —insulation may be added between of the tank 401 and the ground, e.g. to preserve temperatures of water that are more desirable than the geothermal equilibrium temperature.

It is easily understood that all above configurations a-d can be merged into a single underground storage reservoir system where the feed of the water circulating in and out of the tank depends on the availability of sources, the temperature of their water when available, and the mode of operation of the heat-pump heating or cooling so that for example, when the heat pump the source of the available water from other sources does not fit the heating or cooling temporary mode of the system—pipes 402, 403 and 404 are in operation. Alternatively or additionally, when clean water sources are available with water at a temperature more desirable than a geothermal equilibrium (e.g. solar water heaters, E/O coolers) are available for streaming clean water at a preferable temperature—pipe 405 is used for hot water (for example in a heating mode) and/or pipe 406 is used for cold water (for example in a cooling mode) are operational (mode dependent) and/or when sources with quality problems, and/or characterized by fluids that should not be mixed with the stored water, are available for streaming fluids at a temperature that is preferable to the geothermal equilibrium (for example warm waste water, warm fluids from solar heaters that are not based on water and/or cold water from an above ground snow melt stream), either pipes 612 and/or tank 712 are operational. Switching between system modes, and/or operating some of them in parallel, may be managed automatically (e.g. by a controller and/or automatic valves). Optionally the controller will utilize remotely controlled valves and centralized artificial intelligence based on online measurements of water temperatures in different parts of the system, for example temperature measurement that temporarily characterize each of the available water sources.

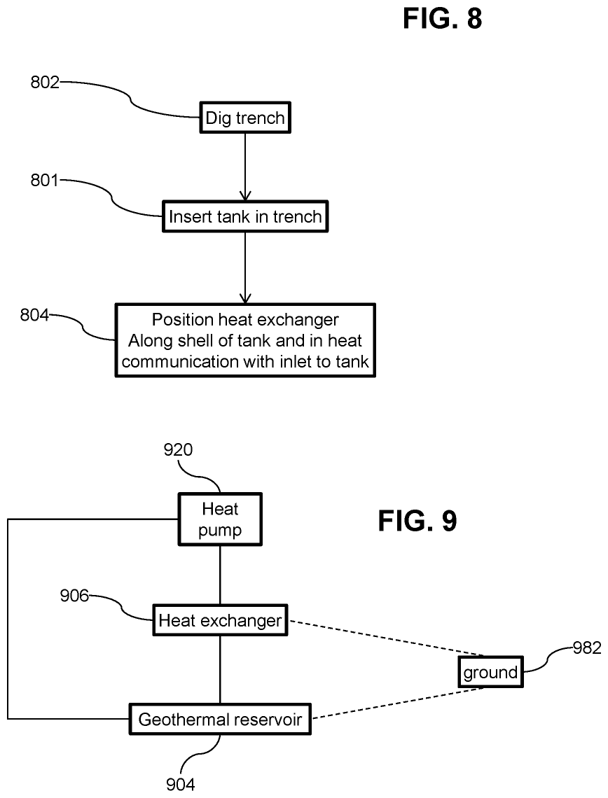

FIG. 8 is a flow chart illustration of installing a geothermal reservoir in accordance with an embodiment of the current invention. For example, in some embodiments, a trench will be dug 802 for a geothermal reservoir. For example, the reservoir (e.g. a tank for storing fluid) may be installed 801 into the trench. Optionally, a heat exchanger will be positioned 804 around the shell of the tank, prior to installing the tank in the trench or during the installation process, and/or the sides of the trench and/or between the tank and the sides of the trench. Optionally, the heat exchanger may include and/or be in heat communication with an inlet tube to the tank. For example, the inlet tube and/or the heat exchanger may surround the tank and/or wind spirally around the tank. Optionally, heat conductive material may be used to fill in between the ground (e.g. the edges of the trench) and the heat exchanger and/or the between the ground and the tank and/or between the heat exchanger and the tank. Alternatively or additionally, insulation may be placed between the heat exchanger and the tank Alternatively or additionally, insulation may be placed between the ground and the tank

FIG. 9 is a block diagram of a heat management system in accordance with an embodiment of the current invention. For example, the system of FIG. 9 may be used with the method of FIG. 8 and/or any of the features described therein may be included in the system of FIG. 9. For example, a geothermal reservoir 904 may be in heat communication with a heat pump 920. Optionally there are two paths for transferring heat between the reservoir 904 and the heat pump 920. For example, a first path includes a heat exchanger 906 in contact with the ground 982. For example, fluid passing along the first path is brought closer to temperature equilibrium with the ground 982 as it travels along the path. For example, the reservoir 904 may include a tank of fluid. Optionally, the heat is transferred between the heat pump 920 and the reservoir 904, for example by transfer of fluid therebetween. For example, the first path may include a tube with a large surface area in contact with the ground 982. Optionally, the high surface area tube runs along a shell of the tank and/or in a space between the tank and the ground 982. In some embodiments, the reservoir 904 is in heat contact with the ground 982. Alternatively or additionally, the reservoir 904 may be insulated from the ground 982. Optionally the first path including the heat exchanger 906 in contact with the ground 982 is the input of the reservoir (e.g. the path of fluid passing from the heat exchanger 920 to the reservoir 904).

In some embodiments, a second path allows heat transfer directly with heat pump 920 with less heat transfer to the ground 982 than along the first path and/or with negligible heat transfer to the ground 982. Optionally the second path is the path by which fluid is transferred from the reservoir 904 to the heat pump 920. Alternatively or additionally, all paths for heat transfer between the reservoir 904 and the heat pump 920 may include significant heat transfer to the ground 982.

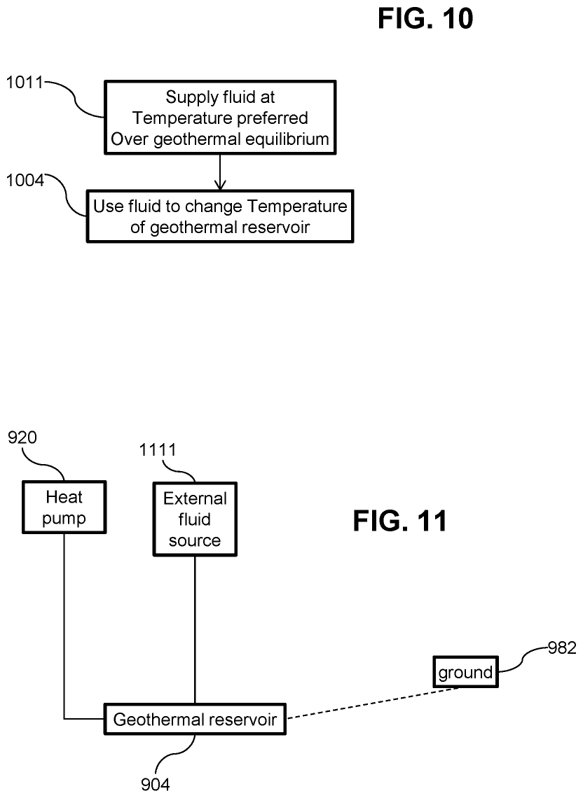

FIG. 10 is a flow chart illustration of changing a temperature of a geothermal reservoir with an external fluid source in accordance with an embodiment of the current invention. In some embodiments, an external fluid source be supplied at a temperature that is more desirable than a geothermal equilibrium temperature. For example, the external source may include heated water (e.g. heated waste flow) in a heating mode and/or cooled water (e.g. from a snow melt stream) in a cooling mode. The fluid may be used to change 1004 the temperature of a geothermal heat reservoir. For example, the reservoir may include a tank of fluid and/or fluid from the external fluid source may be introduced into the tank. Alternatively or additionally, fluid from the source may be brought into heat communication (e.g. as described in FIG. 6 or 7 and/or via a heat exchanger) without physically contacting the reservoir. Optionally, the reservoir may include an underground tank. In some embodiments, the tank may be insulated from the ground. Alternatively or additionally, the tank may be in good heat communication with the ground.

FIG. 11 is a block diagram illustration of a geothermal heating system in accordance with an embodiment of the current invention. For example, a geothermal reservoir 1104 may receive heat from an external fluid source 1111 (for example as described in the description of FIG. 10 and/or including a system module such a solar water heater and/or a photovoltaic panel and/or a E/O cooler). The reservoir 1104 is optionally in good heat contact with ground 982. Alternatively or additionally, the reservoir 1104 may be insulated from the ground 982. In some embodiments, the reservoir may supply fluid to a heat exchanger of a heat pump 920.

It is expected that during the life of a patent maturing from this application many relevant technologies will be developed and the scope of the terms is intended to include all such new technologies a priori.

As used herein the term “about” refers to ±10%

The terms “comprises”, “comprising”, “includes”, “including”, “having” and their conjugates mean “including but not limited to”.

The term “consisting of” means “including and limited to”.

The term “consisting essentially of” means that the composition, method or structure may include additional ingredients, steps and/or parts, but only if the additional ingredients, steps and/or parts do not materially alter the basic and novel characteristics of the claimed composition, method or structure.

As used herein, the singular form “a”, “an” and “the” include plural references unless the context clearly dictates otherwise. For example, the term “a compound” or “at least one compound” may include a plurality of compounds, including mixtures thereof.

Throughout this application, various embodiments of this invention may be presented in a range format. It should be understood that the description in range format is merely for convenience and brevity and should not be construed as an inflexible limitation on the scope of the invention. Accordingly, the description of a range should be considered to have specifically disclosed all the possible subranges as well as individual numerical values within that range. For example, description of a range such as from 1 to 6 should be considered to have specifically disclosed subranges such as from 1 to 3, from 1 to 4, from 1 to 5, from 2 to 4, from 2 to 6, from 3 to 6 etc., as well as individual numbers within that range, for example, 1, 2, 3, 4, 5, and 6. This applies regardless of the breadth of the range.

Whenever a numerical range is indicated herein, it is meant to include any cited numeral (fractional or integral) within the indicated range. The phrases “ranging/ranges between” a first indicate number and a second indicate number and “ranging/ranges from” a first indicate number “to” a second indicate number are used herein interchangeably and are meant to include the first and second indicated numbers and all the fractional and integral numerals therebetween. When multiple ranges are listed for a single variable, a combination of the ranges is also included (for example the ranges from 1 to 2 and/or from 2 to 4 also includes the combined range from 1 to 4).

It is appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable subcombination or as suitable in any other described embodiment of the invention. Certain features described in the context of various embodiments are not to be considered essential features of those embodiments, unless the embodiment is inoperative without those elements.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention. To the extent that section headings are used, they should not be construed as necessarily limiting.

1-14. (canceled)

15. A heat management system comprising:
an underground fluid tank configured as a heat storage reservoir;
a source of fluid having temperatures which differs from a ground temperature around the reservoir;
a fluid and heat transport network interconnecting said heat storage reservoir and said source of fluid;
a controller configured to control flow in said transport network to achieve a desired water temperature.

16. The system of claim 15 further comprising: an aboveground fluid and heat reservoir.

17-18. (canceled)

19. The system of claim 15 further comprising: wherein said fluid and heat transport network includes a valve controlling fluid flow and wherein said controller is configured to control said valve to selectively direct heat flows along said heat transport network.

20. The system of claim 15, wherein said source of fluid includes at least one of a green energy generator, a heat exchanger, a heat pump, a cold external fluid source, a hot external fluid source, a solar water heater and a photovoltaic panel.

21. The system of claim 15, wherein said source of fluid includes multiple sources of fluid at different temperatures.

22. The system of claim 21, wherein said controller controls heat flows between said multiple sources of fluid and between each said multiple sources of fluid and said reservoir.

23. The heat management system of claim 15 wherein the controller is configured to manage flow of the heat in the system to maintain the reservoir at a preset target temperature.

24. The system of claim 23, wherein said target temperature is as close as possible to a preset target value for a specific application which uses water from said reservoir.

25. The system of claim 24, wherein the specific application includes irrigation of a crop.

26-27. (canceled)

28. The system of claim 15, wherein fluid in said underground fluid tank is at a first temperature and further comprising a second tank used for storing another fluid at a different temperature that is further from a geothermal equilibrium than said first temperature.

29. (canceled)

30. The heat management system of claim 15, wherein said heat transport network includes a network of interconnecting pipes and valves and/or wherein said controller controls opening and closing of said valves to direct fluid flow in said network, utilizing logic embedded in said controller.

31. (canceled)

32. The system of claim 15, including a high surface area tube directed along a shell of said reservoir wherein said high surface area tube is connected to an inlet of said tank.

33-44. (canceled)

45. A method of geothermal heat management comprising:
importing fluid at temperature different than a geothermal equilibrium;
transferring heat between said fluid to a geothermal reservoir to achieve a desired temperature fluid;
exporting said desired temperature fluid.

46. The method of claim 45, wherein said reservoir includes a fluid tank, the method further comprising inserting said imported fluid into said tank.

47. The method of claim 45, wherein said reservoir includes a geothermal tank the method further comprising:
separating said imported fluid from a fluid in said geothermal tank and transferring heat between said imported fluid and said fluid in said geothermal tank.

48. The method of claim 45, further comprising:
controlling a temperature of fluid stored in said reservoir including at least one of maximizing the temperature of the stored fluid depending on availability of imported fluid, minimizing the temperature of the stored fluid, depending on availability of imported fluid, and stabilizing the temperature of the stored fluid in a value different from the geothermal equilibrium.

49. The method of claim 45, wherein said reservoir includes a geothermal tank the method further comprising:
mixing said imported fluid with said fluid in said geothermal tank.

50. The method of claim 45, further comprising:
supplying a heat exchanger in heat communication with a ground;
passing said imported fluid through said heat exchanger.

51. The method of claim 45, further comprising:
bringing the fluid in said reservoir to a desired temperature.

52. The system of claim 15, wherein said fluid and heat transport network includes a valve controlling fluid flow to a heat exchanger and wherein said controller is configured to control said valve to selectively direct heat flow to said heat exchanger.
